(19) United States
(12) Patent Application Publication
(10) Pub. No.: US 2008/0096488 A1
(43) Pub. Date: Apr. 24, 2008

(54) Apparatus and method for transmitting and receiving data in a communication system

(75) Inventors: Myeon-Gyun Cho, Seongnam-si (KR); Sung-Jin Kim, Suwon-si (KR); Ho-Jin Kim, Seoul (KR); In-Soo Hwang, Gyeongsan-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/645,415

(22) Filed: Dec. 26, 2006

(30) Foreign Application Priority Data
Dec. 26, 2005 (KR) 130039/2005

(51) Int. Cl. H04B 1/00; H04B 1/02

(52) U.S. Cl. 455/69; 455/101

(57) ABSTRACT

For data transmission/reception in a communication system, a transmitter precodes data to be transmitted via at least two antennas, with use of at least one precoding matrix of a predetermined rank, and transmits the precoded data to a receiver. A receiver receives a signal which is precoded with a precoding matrix of a predetermined rank, detects the precoding matrix, calculates a sum rate corresponding to the detected precoding matrix, and feeds back quality information on a channel formed between a transmitter and the receiver when the calculated sum rate falls within a predetermined rank among sum rates calculated for all precoding matrixes.

### PRIORITY

This application claims the benefit under 35 U.S.C. § 119(a) of a Korean Patent Application filed in the Korean Intellectual Property Office on Dec. 26, 2005 and assigned Serial No. 2005-130039, the disclosure of which is incorporated herein by reference.

### BACKGROUND OF THE INVENTION

1. Field of the Invention

The present invention relates generally to a communication system, and in particular, to an apparatus and method for transmitting and receiving data in a communication system.

2. Description of the Related Art

A Per User Unitary Rate Control-Multiple Input Multiple Output (PU²RC-MIMO) scheme is based on a Multiple Input Multiple Output (MIMO) scheme that uses a plurality of antennas. Accordingly, the PU²RC-MIMO scheme is a kind of a Spatial Division Multiple Access (SDMA) scheme that can obtain overall system performance gain by using several spatial-domain data streams for several users.

FIG. 1 shows a transceiver using a general PU²RC-MIMO scheme. It is assumed that a transmitter represents, for example, a Base Station (BS) 100, and a receiver represents, for example, a Mobile Station (MS) 150. The BS 100 includes a transmission stream selector 111 and a beamformer 113, and the MS 150 includes a Minimum Mean Square Error (MMSE) unit 151 and a reception stream selector 153.

The transmission stream selector 111 receives data streams to be transmitted to MSs, and selects desired transmission data streams among the received data streams. The streams selected by the transmission stream selector 111 are output to the beamformer 113.

The beamformer 113 encodes the selected data streams using precoding matrixes, i.e. unitary matrixes, V₁, V₂, . . . V_{G}, beamforms the coded signals, and transmits the beamformed signals via a plurality of, for example, M antennas. The preceding matrixes are matrixes for minimizing interferences between signals of MSs by guaranteeing orthogonality between signals transmitted over the air by a transmitter, i.e. BS.

The MMSE unit 151 performs channel estimation using an MMSE scheme, and receives signals from the transmitter using the estimated channel information. The data streams received at the MMSE unit 151 are output to the reception stream selector 153.

The reception stream selector 153 receives the streams output from the MMSE unit 151 using the precoding matrix used in the transmitter.

The BS 100 sends data streams using precoding matrixes V₁, . . . , V_{G}, adaptively allocates streams according to per-user spatial-domain channel situations, and transmits the allocated streams to the MS 150. In order for the BS 100 to adaptively utilize the spatial resources in this way, each MS, for example, the MS 150, should necessarily provide the BS 100 with information on a Signal-to-Interference and Noise Ratio (SINR) at which it can receive signals when the BS 100 transmits the signals using the precoding matrixes. This operation is referred to as “Channel Quality Information (CQI) feedback.” With reference to FIG. 2, a description will now be made of a structure of a transmitter using the general PU²RC-MIMO scheme.

FIG. 2 shows a transmitter using a general PU²RC-MIMO scheme. The transmitter, i.e. BS, includes a grouper 211, a scheduler 213, Adaptive and Modulation Coding (AMC) units 215, a precoder 217, and a controller 223. The precoder 217 includes precoding matrix appliers 219 and mixers 221.

The grouper 211 receives data streams of MSs, groups the data streams of the MSs into a plurality of groups under the control of the controller 223, and outputs the grouped data streams to the scheduler 213.

The scheduler 213, under the control of the controller 223, selects the grouped data streams and generates precoding matrixes used for precoding the data streams. The scheduler 213 outputs the scheduled data streams to the AMC units 215, and outputs the precoding matrixes to the precoder 217.

The AMC units 215, under the control of the controller 223, perform modulation and coding on the data streams scheduled by the scheduler 213, using the AMC scheme. The AMC units 215 output the modulated/coded data streams to the precoder 217.

The precoder 217 precodes the data streams output from the AMC units 215 using the precoding matrixes output from the scheduler 213. The precoder 217 can allow the precoded data streams transmitted to the MSs to maintain orthogonality between them.

The precoder 217 has an advantage of receiving the precoding matrixes and precoding the data streams using the preceding matrixes.

The precoding matrix appliers 219 in the precoder 217 receive the precoding matrixes, apply the received precoding matrixes to the data streams input to the precoder 217 for preceding, and output the precoded data streams to the mixers 221.

The mixers 221 mix the signals output from the precoding matrix appliers 219, and transmit the mixed signals via antennas Ant #0 to Ant #(M−1).

The number of the precoding matrix appliers 219 and the mixers 221 in the precoder 217 can be two or more, so the number of the antennas Ant #0 to Ant #(M−1) connected to the mixers 221 can also be two or more.

The controller 223 receives CQI fed back from a plurality of MSs in communication with the BS, and indexes of the precoding matrixes. The controller 223 controls the grouper 211, the scheduler 213 and the AMC units 215 using the received CQI.

For a description of types of the CQI feedbacks from the MSs to the BS, it will be assumed that the BS uses a codebook composed of, for example, G precoding matrixes, and uses a PU²RC scheme that uses L data streams.

First, a full CQI feedback scheme will be described. The full CQI feedback scheme feeds back channel qualities for L data streams for all candidate precoding matrixes and each of the precoding matrixes. In this case, a load of the full CQI feedback scheme is I_{full}=G×Q×L, where Q denotes a resolution for representing the data streams in units of bits. As described above, the full CQI feedback scheme has a high system load due to the feedback.

Second, a partial CQI feedback scheme will be described. The partial CQI feedback scheme feeds back an index of a preceding matrix having the best performance as a result of previous calculation, and CQI for each of the then individual streams. A load of the partial CQI feedback scheme is Iₚₐᵣₜᵢₐₗ=log₂G+Q×L, and the partial CQI feedback scheme is a feedback scheme that gives a trade-off between the most realistic performance and redundancy, i.e. system load.

Third, a reduced CQI feedback scheme will be described. The reduced CQI feedback scheme feeds back only one stream having the highest preceding SINR among L streams, and feeds back an index of the then precoding matrix and an index of the corresponding data stream. A load of the reduced CQI feedback scheme is I_{reduced}=log₂(G·L)+1×Q, and the reduced CQI feedback scheme can reduce the system load due to its low load, but may cause performance degradation.

For precoding, the BS can use the precoding matrix having the highest sum rate acquired using SINR information for individual streams, received from the MSs through the above CQI feedback. The CQI information acquired by the BS for individual streams, and preceding matrixes based on the CQI information are shown in Table 1.

TABLE 1

| Precoding | | | | |
|---|---|---|---|---|
| Matrix | V₁ | V₂ | . . . | V_{G} |
| Stream 1 | SINR_{1, 1} | SINR_{2, 1} | . . . | SINR_{G, 1} |
| Stream 2 | SINR_{1, 2} | SINR_{2, 2} | . . . | SINR_{G, 2} |
| . | . | . | . | . |
| . | . | . | . | . |
| . | . | . | . | . |
| Stream M | SINR_{1, M} | SINR_{2, M} | . . . | SINR_{G, M} |
| Sum Rate | R₁ | R₂ | | R_{G} |

In Table 1, the BS selects a preceding vector having the highest sum rate acquired using SINRs of individual data streams. The sum rate is a value acquired using a log function for the SINR, and the BS selects the highest sum rate, thereby acquiring a preceding matrix having the highest performance for data transmission. Subscripts of the SINR indicate an MS index and a stream index, respectively. Precoding matrixes selected for MSs are shown in Table 2.

TABLE 2

| | MS 1 | MS 2 | MS 3 | MS 4 | MS 5 |
|---|---|---|---|---|---|
| Stream 1 | SINR_{1, 1} | SINR_{2, 1} | SINR_{3, 1} | SINR_{4, 1} | SINR_{5, 1} |
| Stream 2 | SINR_{1, 2} | SINR_{2, 2} | SINR_{3, 2} | SINR_{4, 2} | SINR_{5, 2} |
| Stream 3 | SINR_{1, 3} | SINR_{2, 3} | SINR_{3, 3} | SINR_{4, 3} | SINR_{5, 3} |
| Stream 4 | SINR_{1, 4} | SINR_{2, 4} | SINR_{3, 4} | SINR_{4, 4} | SINR_{5, 4} |
| Precoding | V₂ | V₁ | V₁ | V₂ | V₁ |
| Matrix | | | | | |

Shown in Table 2 are precoding vectors selected for MSs by the BS. The BS groups data streams according to MS having the same precoding vector. A grouper of the BS can group data streams of MSs using the precoding matrixes. For example, in Table 2, the BS can divide the MSs into a first group of MS 2, MS 3 and MS 5 corresponding to the precoding matrix V₁, and a second group of MS 1 and MS 4 corresponding to the precoding matrix V₂.

A scheduler of the BS uses individual SINRs for MSs having the precoding matrixes, and allocates each data stream to an MS having the highest SINR for the data stream. Shown in Table 3A and 3B are methods in which the scheduler of the BS allocates each precoding matrix to an MS having the highest SINR in this manner.

TABLE 3A

| | | | | | Se- |
|---|---|---|---|---|---|
| | MS 1 | MS 2 | MS 5 | Max | lect |
| Stream 1 | SINR_{1,1} | 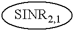 | SINR_{5,1} | SINR_{3,1} | MS 3 |
| Stream 2 | 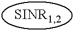 | SINR_{2,2} | SINR_{5,2} | SINR_{2,2} | MS 2 |
| Stream 3 | SINR_{1,3} | SINR_{2,3} | 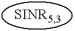 | SINR_{5,3} | MS 5 |
| Stream 4 | SINR_{1,4} | 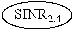 | SINR_{5,4} | SINR_{3,4} | MS 3 |

| | | | |
|---|---|---|---|
| Pre- | all V₁ | Sum | C₁ |
| coding | | Rate | |
| Matrix | | | |

TABLE 3B

| MS 1 | MS 4 | Max | Select |
|---|---|---|---|
| SINR_{1,1} | 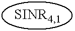 | SINR_{4,1} | MS 4 |
| 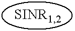 | SINR_{4,2} | SINR_{1,2} | MS 1 |
| 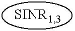 | SINR_{4,3} | SINR_{1,3} | MS 1 |
| SINR_{1,4} | 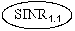 | SINR_{4,4} | MS 4 |

| | | |
|---|---|---|
| all V₂ | Sum | C₂ |
| | Rate | |

As shown in Table 3A and 3B, the scheduler performs scheduling in such a way of allocating MSs for individual data streams of the precoding matrixes V₁ and V₂. Next, the scheduler calculates sum rates C₁, C₂, . . . , CG for individual groups of the precoding matrixes, finally selects the highest sum rate among the sum rates of individual precoding matrixes, and performs precoding using the corresponding precoding matrix. The scheduler transmits data streams to the selected users. Therefore, the BS broadcasts, to the MSs, the optimal precoding matrix index selected through the above operation and allocation information for individual data streams.

As the number G of candidate precoding matrixes selectable by the MS increases, the amount of CQI feedback that each MS should transmit is determined as follows. It will be assumed herein that L denotes the number of streams and an SINR of each individual stream is expressed as a Q-bit resolution.

(1) A load of the full CQI feedback scheme for Nu MSs is I_{full}=(G×Q×L)×Nu;

(2) A load of the partial CQI feedback scheme for Nu MSs is Iₚₐᵣₜᵢₐₗ=(log₂G+Q×L)×Nu; and

(3) A load of the reduced CQI feedback scheme for Nu MSs is Iₚₐᵣₜᵢₐₗ=(log₂(G×L)+1×Q)×Nu.

A performance graph of the CQI feedbacks is shown in FIG. 3.

FIG. 3 shows a performance graph of the general feedback processes. For the CQI feedback processes described above, it can be noted that as the codebook size G increases, the number of MSs increases, thus not securing performance improvement. For the full CQI feedback, even though all possible cases are compared, there is no difference in system performance, i.e. average data transmission capacity, due to the change in the G. For the partial CQI feedback, as the G increases, the system performance decreases. For the reduced CQI feedback, it is difficult to acquire multi-user diversity gain. Therefore, the reduced CQI feedback scheme is lower in system performance than the full CQI feedback scheme and the partial CQI feedback scheme.

In conclusion, in the communication system, as the number G of the precoding matrixes increases, the number of MSs that will make contention over each precoding matrix decreases, thus making it impossible to acquire diversity gain. Therefore, the communication system is a need to prevent system performance reduction due to the increase in the G and reduce the amount of CQI feedback.

### SUMMARY OF THE INVENTION

An aspect of the present invention is to address at least the problems and/or disadvantages and to provide at least the advantages described below. Accordingly, an aspect of the present invention is to provide an apparatus and method for transmitting and receiving data in a communication system.

Another aspect of the present invention is to provide a data transmission/reception apparatus and method for preventing performance reduction due to an increase in the number of precoding matrixes in a communication system.

Still another aspect of the present invention is to provide an apparatus and method for reducing the amount of CQI feedback in a communication system.

Yet another aspect of the present invention is to provide a data transmission/reception apparatus and method for maximizing multi-user diversity gain due to an increase in the number of MSs that make contention over each precoding matrix in a multi-antenna communication system.

According to one aspect of the present invention, there is provided a method for transmitting data in a communication system. In the data transmission method, a transmitter precodes data to be transmitted via at least two antennas, with use of at least one precoding matrix of a predetermined rank, and transmits the precoded data to a receiver.

According to another aspect of the present invention, there is provided a method for receiving data in a communication system. In the data reception method, a receiver receives a signal which is precoded with a preceding matrix of a predetermined rank; detects the precoding matrix, and calculates a sum rate corresponding to the detected precoding matrix; and feeds back quality information on a channel formed between a transmitter and the receiver when the calculated sum rate falls within a predetermined rank among sum rates calculated for all precoding matrixes.

According to still another aspect of the present invention, there is provided an apparatus for transmitting data in a communication system. The data transmission apparatus includes a transmitter for preceding data to be transmitted via at least two antennas, with use of at least one precoding matrix of a predetermined rank, and transmitting the precoded data to a receiver.

According to yet another aspect of the present invention, there is provided an apparatus for receiving data in a communication system. The data reception apparatus includes a receiver for receiving a signal which is precoded with a precoding matrix of a predetermined rank, detecting the precoding matrix, calculating a sum rate corresponding to the detected precoding matrix, and feeding back quality information on a channel formed between a transmitter and the receiver when the calculated sum rate falls within a predetermined rank among sum rates calculated for all precoding matrixes.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a structure of a transceiver using a general PU²RC-MIMO scheme;

FIG. 2 is a diagram schematically illustrating a structure of a transmitter using a general PU²RC-MIMO scheme;

FIG. 3 is a diagram illustrating a performance graph of general feedback processes;

FIG. 4 is a diagram schematically illustrating a CQI feedback operation of a transceiver according to the present invention;

FIG. 5 is a diagram schematically illustrating a structure of a BS according to the present invention;

FIG. 6 is a diagram schematically illustrating a structure of an MS according to the present invention

FIG. 7 is a flowchart schematically illustrating an operation of a BS according to the present invention;

FIG. 8 is a flowchart schematically illustrating an operation of an MS according to the present invention;

FIG. 9 is a performance graph of a partial CQI feedback scheme according to the present invention; and

FIG. 10 is a performance graph of a reduced CQI feedback scheme according to the present invention.

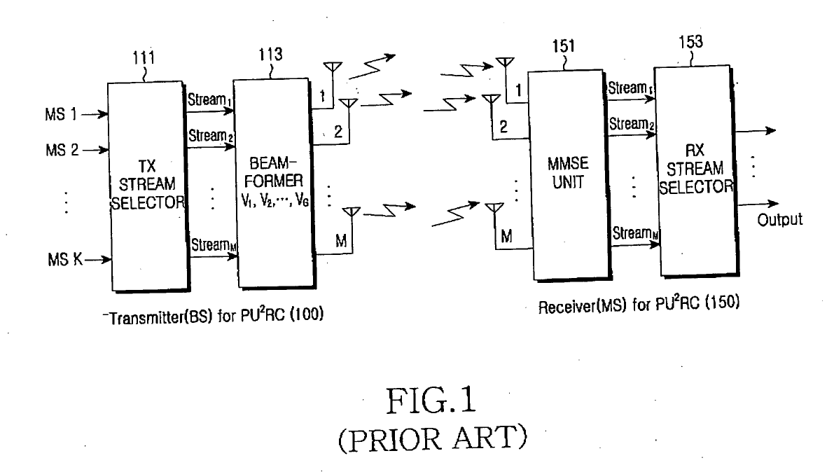

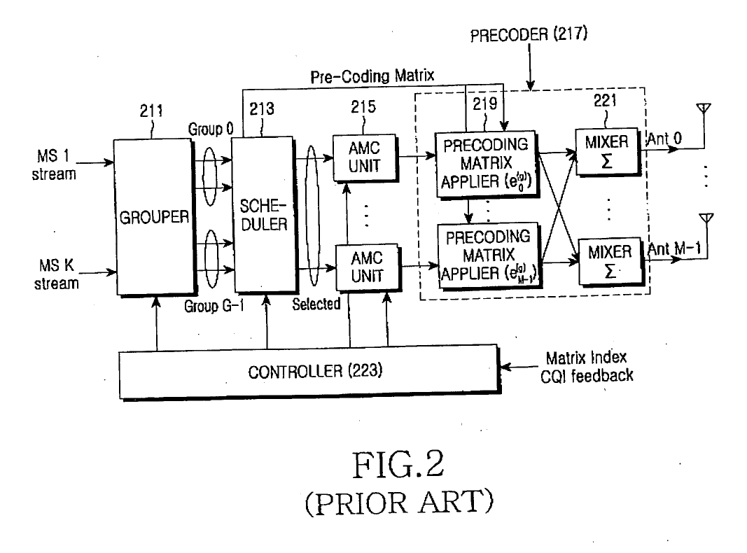

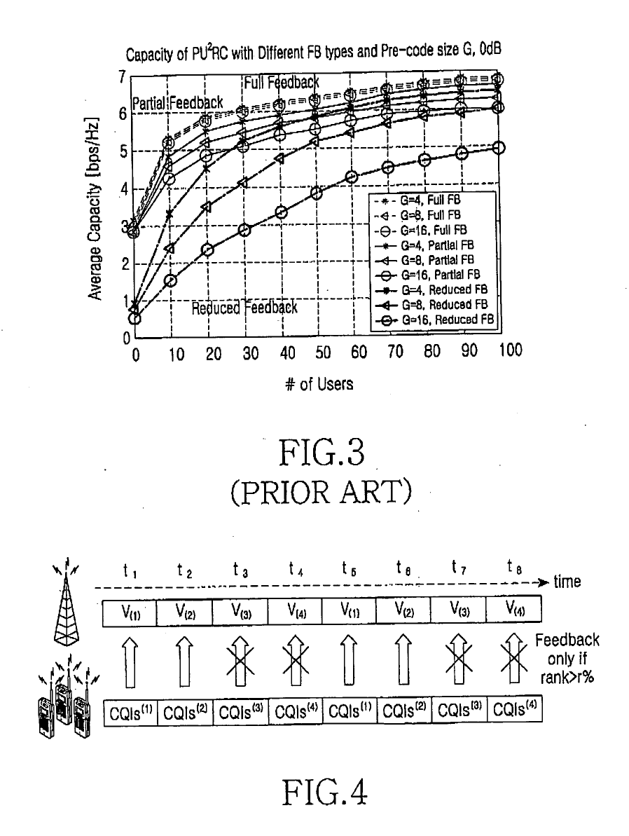

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides data transmission/reception in a communication system using a multi-antenna scheme, for example, Multiple Input Multiple Output (MIMO) scheme, and maximizes the system performance by adaptively allocating several data streams to several MSs. For this purpose, a transmitter according to the present invention circulates at least one precoding matrix, i.e. unitary matrix, in a predetermined order, precodes transmission data with the circulated precoding matrix, and transmits the precoded data to a receiver. The receiver feeds back Channel Quality Information (CQI) when the sum rate of the precoding matrix transmitted by the transmitter is included in (or falls within) the top 50%. The transmitter and the receiver both store predetermined ranks of the precoding matrixes. The transmitter that transmits data using the precoding matrixes can be, for example, a base station (BS), and the receiver that feeds back the CQI can be, for example, a mobile station (MS). The precoding matrix is a matrix for minimizing interference between signals of MSs by guaranteeing orthogonality between signals that the transmitter, i.e. BS, transmits over the air. Therefore, with the use of the precoding matrixes, it is possible to minimize interference between signals of MSs.

Preferred embodiments of the present invention will be described herein with reference to a communication system using a MIMO scheme, especially to a communication system employing a Per User Unitary Rate Control-Multiple Input Multiple Output (PU²RC-MIMO) scheme, by way of example. Therefore, the present invention can be applied to any communication system employing at least one or more antennas. Next, with reference to FIG. 4, a description will be made of a transceiver according to the present invention.

FIG. 4 shows a CQI feedback operation of a transceiver according to the present invention. A transmitter, i.e. BS, sequentially circulates precoding matrixes V₁ to V₄ in a predetermined order for predetermined time intervals t₁, t₂, t₃, t₄, t₅, t₆, t₇, and t₈. The BS precodes transmission data with the circulated preceding matrixes, and transmits the precoded data.

A receiver, i.e. MS, receiving the precoded data, measures CQI, for example, Signal-to-Interference and Noise Ratio (SINR), for its data stream. Each MS transmits the measured CQI to the BS, and the BS calculates sum rates according to the measured SINRs. The Sum_rate for MS k is shown in Equation (1).

$$Sum\_rate for MS k = {\sum }_{m = 1}^{{M}_{1}} {γ}_{k , m}^{( g )} \qquad ( 1 )$$

where γ_{k,m}^{(g)} denotes mth Signal to Noise Ratio (SNR) that kth MS uses Vg precoding matrix. The sum rate is a value acquired using a sum of SINR information for each data stream. The MS feeds back the CQI to the BS when the sum rate for the SINR based on the preceding matrix used by the BS falls within a predetermined reference value. The predetermined reference value can be set to the top r %, for example, top 50%, of the sum rates calculated for individual precoding matrixes by the MS. The MS recognizes the precoding matrixes sequentially circulated by the BS. Also, the predetermined reference value can be predetermined using threshold of sum rate, and if the sum rate is over the threshold, the MS could feed back the CQI.

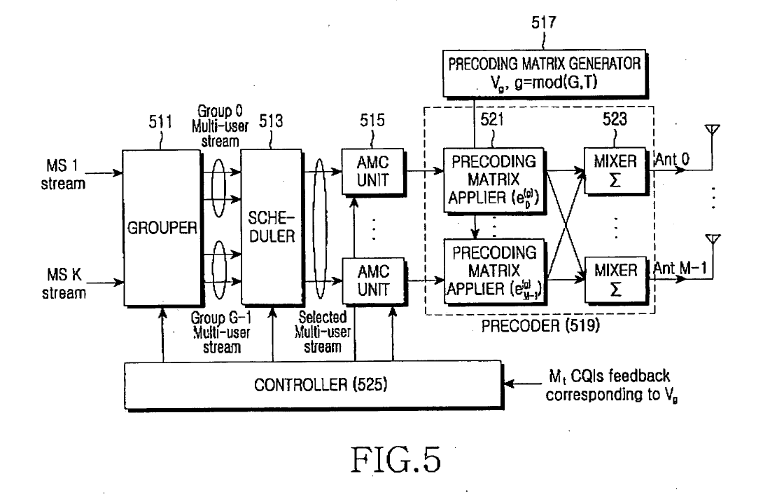

Next, with reference to FIG. 5, a description will be made of a structure of a BS according to the present invention.

FIG. 5 shows a BS according to the present invention. The BS includes a grouper 511, a scheduler 513, Adaptive and Modulation Coding (AMC) units 515, a precoding matrix generator 517, a precoder 519, and a controller 525. The precoder 519 includes precoding matrix appliers 521 and mixers 523.

The grouper 511 receives data streams of MSs, groups the data streams of the MSs into a plurality of groups under the control of the controller 525, and outputs the grouped data streams to the scheduler 513.

The scheduler 513, under the control of the controller 525, selects the grouped data streams, and outputs the scheduled data streams to the AMC units 515.

The AMC units 515, under the control of the controller 525, perform modulation and coding on the data streams scheduled by the scheduler 513, using the AMC scheme. The AMC units 515 output the modulated/coded data streams to the precoder 519.

The precoding matrix generator 517 generates precoding matrixes by sequentially circulating the precoding matrixes in a predetermined order, and outputs the generated precoding matrixes to the precoder 519. The precoding matrix generator 517 can generate indexes of the preceding matrixes through a modulo operation as shown in the drawing. The precoding matrixes used by the BS can be previously stored in a buffer of the preceding matrix generator 517, and the precoding matrix generator 517 can sequentially circulate the stored precoding matrixes for individual indexes as described above, and output the circulated precoding matrixes to the precoder 519. The precoding matrix generator 517 can either spontaneously generate the precoding matrixes, or generate the preceding matrixes under the control of the controller 517.

The precoder 519 precodes the data streams output from the AMC units 515 using the precoding matrixes output from the precoding matrix generator 517. The precoder 519 can allow the precoded data streams transmitted to the MSs to maintain orthogonality between them.

The precoding matrix appliers 521 in the precoder 519 receive the precoding matrixes, apply the received preceding matrixes to the data streams input to the precoder 519 for precoding, and output the precoded data streams to the mixers 523.

The mixers 523 mix the signals output from the precoding matrix appliers 521, and transmit the mixed signals via antennas Ant #0 to Ant #(M−1).

The number of the precoding matrix appliers 521 and the mixers 523 in the precoder 519 can be two or more, so the number of the antennas Ant #0 to Ant #(M−1) connected to the mixers 523 can also be two or more.

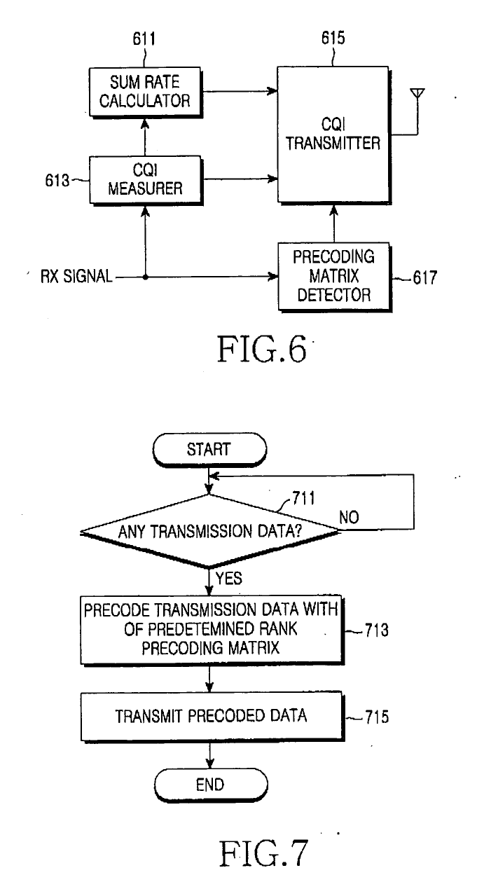

The controller 525 receives CQI based on the precoding matrixes, from a plurality of MSs in communication with the BS. The controller 525 controls the grouper 511, the scheduler 513 and the AMC units 515 using the received CQI. In addition, the controller 525 can control the preceding matrix generator 517 so as to sequentially generate precoding matrixes in a predetermined order. Next, with reference to FIG. 6, a description will be made of a structure of an MS that receives the data transmitted by the BS.

FIG. 6 shows an MS according to the present invention. The MS includes a sum rate calculator 611, a CQI measurer 613, a CQI transmitter 615 and a preceding matrix detector 617.

The CQI measurer 613 receives a signal from a BS, and measures a CQI, for example, SINR, of each data stream. The CQI measurer 613 provides the measured CQI to the sum rate calculator 611 and the CQI transmitter 615.

The sum rate calculator 611 calculates a sum rate of each precoding matrix, and outputs the sum rate and its associated precoding matrix to the CQI transmitter 615. The sum rate calculator 611 receives the CQI from the CQI measurer 613, and calculates the sum rate using the CQI information of each data stream for each precoding matrix.

The precoding matrix detector 617 detects, from the received signals, the precoding matrix currently used by the BS for data transmission, and outputs the detected precoding matrix to the CQI transmitter 615. The precoding matrix detector 617 acquires the precoding matrix used for the currently received signal, by recognizing information on the precoding matrixes sequentially transmitted from the BS.

The CQI transmitter 615 determines transmission of the CQI by checking whether the sum rate of the detected precoding matrix falls within a predetermined reference value among the sum rates of all precoding matrixes. The sum rate is a value acquired using CQI for each data stream. The MS transmits the CQI to the BS when the sum rate falls within the top r % of the sum rates calculated for precoding matrixes. For example, for r=50, the MS transmits the CQI to the BS, if the sum rate of the current precoding matrix falls within the top 50% of the sum rates of all precoding matrixes. The CQI transmitter 615 quantizes the CQI, for example, SINR, of each data stream in a bit-resolution, and transmits the quantized CQI to the BS.

However, the CQI transmitter 615 transmits no CQI to the BS, if the sum rate of the current precoding matrix does not fall within the top 50% ((G/2)^{th} highest sum rate) of the sum rates of all precoding matrixes.

Compared with the existing partial CQI feedback scheme in which the MS designates and transmits one precoding matrix guaranteeing the highest sum rate, the new CQI feedback scheme allows a plurality of MSs to make contention over each precoding matrix, thereby acquiring multi-user diversity gain. In addition, the new CQI feedback scheme can reduce the amount of CQI feedback because there is no need to constantly feed back the CQI like in the existing partial CQI feedback scheme. If the r is set to 50, the new CQI feedback scheme can halve the amount of CQI feedback. Next, with reference to FIG. 7, a description will be made of an operation of a BS apparatus according to the present invention.

FIG. 7 shows an operation of a BS according to the present invention. A BS determines in step 711 whether it has data to transmit to MSs. If there is no transmission data in step 711, the BS returns to step 711. However, if there is transmission data in step 711, the BS proceeds to step 713.

In step 713, the BS precodes the transmission data using a preceding matrix of a predetermined rank. The precoding is performed using precoding matrixes for a predetermined time interval, and the precoding matrixes are sequentially circulated. For example, if there are four precoding matrixes V₁ to V₄, the precoding matrixes are sequentially circulated in order of V₁→V₂→V₃→V₄→V₁→V₂→V₃→V₄→V₁→V₂→ . . . , performing the preceding.

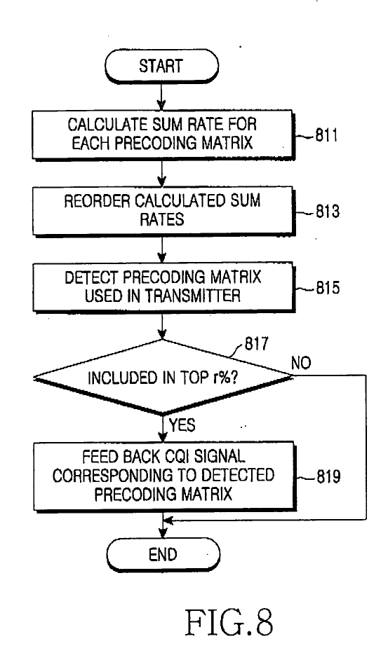

In step 715, the BS transmits the precoded data to the MSs. Next, with reference to FIG. 8, a description will be made of an operation of an MS according to the present invention.

FIG. 8 shows an operation of an MS according to the present invention. The MS calculates a sum rate of each precoding matrix in step 811. The sum rate is calculated using CQI, for example, SINR, of each data stream.

In step 813, the MS reorders the sum rates calculated for individual precoding matrixes. In step 815, the MS detects a precoding matrix used in a BS, and calculates a sum rate corresponding to the detected precoding matrix.

In step 817, the MS determines whether the sum rate of the detected precoding matrix is included in the top r % among the sum rates of all the precoding matrixes. The variable ‘r’ can be set according to system situation. If the sum rate of the detected precoding matrix falls within a predetermined reference value, i.e. the top r %, the MS proceeds to step 819.

In step 819, the MS transmits a CQI signal corresponding to the detected precoding matrix to the BS. However, if it is determined in step 817 that the sum rate of the detected preceding matrix does not fall within the reference value, i.e. the top r %, the MS ends the operation without transmitting the CQI.

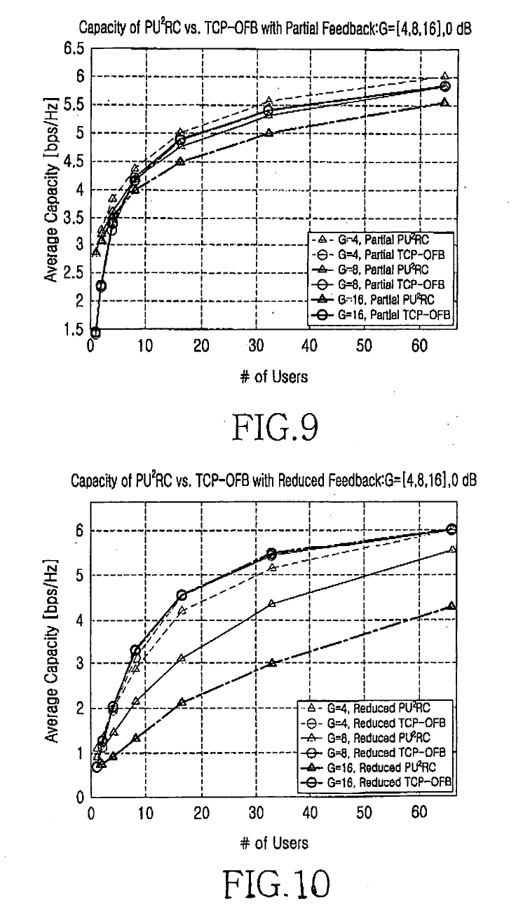

FIG. 9 shows a performance graph of an existing partial CQI feedback scheme and a new partial CQI feedback scheme proposed in the present invention. FIG. 10 shows a performance graph of an existing reduced CQI feedback scheme and a new reduced CQI feedback scheme proposed in the present invention. In the graphs of FIGS. 9 and 10, r is set to 50, by way of example.

FIG. 9 is a performance graph of a partial CQI feedback scheme according to the present invention. For G=4, if the number of available users is, for example, 10 or more, even though sum rates of precoding matrixes are reordered, it is possible to acquire multi-user diversity gain by virtue of data stream allocation through contention. In addition, it is possible to obtain the gain by selecting the case where the sum rate falls within a predetermined range for the reordered sum rates of the precoding matrixes.

Further, it can be appreciated that the new method proposed in the present invention is superior in performance than the existing method, because the MS acquires the multi-user diversity gain as the number of MSs that will make contention over each precoding matrix increases for G=8 and G=16.

FIG. 10 is a performance graph of a reduced CQI feedback scheme according to the present invention. It is noted that the reduced CQI feedback scheme shows good performance for all of G=4, 8 and 16, and reduces the amount of CQI feedback by about 50%.

The amount of CQI feedback for each CQI feedback scheme is shown in Table 4.

TABLE 4

| Feedback Scheme | Feedback Load | (bits) |
|---|---|---|
| PU²RC + Full | Nu × G × L × Q | 3200 |
| PU²RC + Partial | Nu × (log2G + L × Q) | 460 |
| PU²RC + Reduced | Nu × (log2G · L + 1 · Q) | 200 |
| TCP-OFB + Partial | Nu × r · (log2G + L × Q) | 200 |
| TCP-OFB + Reduced | Nu × r · (log2G · L + 1 · Q) | 70 |

Nu = 20, G = 8, r = 0.5(50%), L = 4, Q = 5 bits

It can be understood from Table 4 that the proposed Transmitter Controlled Precoding and Opportunistic Feedback (TCP-OFB) CQI feedback schemes, compared with the existing CQI feedback scheme, contribute to an increase in the channel capacity due to reduction in the amount of CQI feedback.

As can be understood from the foregoing description, use of data transmission/reception in a communication system according to the present invention can prevent performance degradation even though the number of precoding matrixes increases. In addition, the present invention can reduce the amount of CQI feedback. Further, the present invention can maximize multi-user diversity gain due to the increase in number of MSs that make contention over each preceding matrix.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting data in a communication system, the method comprising:
precoding, by a transmitter, data to be transmitted via at least two antennas, with use of at least one precoding matrix of a predetermined rank; and
transmitting the precoded data to a receiver.

2. The method of claim 1, wherein the precoding step comprises sequentially circulating precoding matrixes.

3. The method of claim 1, wherein the precoding step comprises precoding the data with use of the precoding matrix for a predetermined time interval.

4. The method of claim 1, further comprising:
receiving, by the transmitter, channel quality information from the receiver, and grouping data to be transmitted to the receiver;
scheduling the precoded data; and
applying Adaptive and Modulation Coding (AMC) to the scheduled data, and performing the precoding on the AMC-processed data.

5. A method for receiving data in a communication system, the method comprising:
receiving, by a receiver, a signal which is precoded with a precoding matrix of a predetermined rank;
detecting the precoding matrix, and calculating a sum rate corresponding to the detected precoding matrix; and
feeding back quality information on a channel formed between a transmitter and the receiver when the calculated sum rate falls within a predetermined rank among sum rates calculated for all precoding matrixes.

6. The method of claim 5, wherein the sum rate is calculated using channel quality information of each data stream.

7. The method of claim 6, wherein the channel quality information comprises a Signal-to-Interference and Noise Ratio (SINR).

8. The method of claim 5, wherein the feeding back step comprises feeding back channel quality information of each data stream transmitted via each antenna of the transmitter.

9. An apparatus for transmitting data in a communication system, the apparatus comprising:
a transmitter for precoding data to be transmitted via at least two antennas, with use of at least one precoding matrix of a predetermined rank, and transmitting the precoded data to a receiver.

10. The apparatus of claim 9, wherein the transmitter comprises:
a preceding matrix generator for generating at least one of precoding matrixes in a predetermined order; and
a precoder for precoding transmission data with use of the generated preceding matrixes.

11. The apparatus of claim 10, wherein the precoding matrix generator sequentially circulates the precoding matrixes.

12. The apparatus of claim 10, wherein the precoder precodes the data with use of the preceding matrix for a predetermined time interval.

13. The apparatus of claim 9, wherein the transmitter comprises:
a grouper for receiving channel quality information from the receiver, and grouping data to be transmitted to each receiver;
a scheduler for scheduling the precoded data; and
an Adaptive and Modulation Coding (AMC) applier for applying AMC to the scheduled data, and outputting the result to the precoder.

14. An apparatus for receiving data in a communication system, the apparatus comprising:
a receiver for receiving a signal which is precoded with a precoding matrix of a predetermined rank, detecting the precoding matrix, calculating a sum rate corresponding to the detected preceding matrix, and feeding back quality information on a channel formed between a transmitter and the receiver, if the calculated sum rate falls within a predetermined rank among sum rates calculated for all precoding matrixes.

15. The apparatus of claim 14, wherein the receiver comprises:
a sum rate calculator for calculating sum rates corresponding to all precoding matrixes.
a channel quality information measurer for measuring channel quality information using a transmission signal from the transmitter;
a precoding matrix detector for detecting a precoding matrix using the received signal; and
a channel quality information transmitter for feeding back quality information on a channel formed to the transmitter, if a sum rate of the detected precoding matrix falls within a predetermined rank among the sum rates calculated for all the precoding matrixes.

16. The apparatus of claim 15, wherein the sum rate calculator calculates the sum rate using channel quality information of each data stream.

17. The apparatus of claim 16, wherein the channel quality information comprises a Signal-to-Interference and Noise Ratio (SINR).

18. The apparatus of claim 14, wherein the receiver feeds back channel quality information of each data stream transmitted via each antenna of the transmitter.
